(19) United States
(12) Patent Application Publication
(10) Pub. No.: US 2008/0272601 A1
(43) Pub. Date: Nov. 6, 2008

(54) Electrical energy from naturally moving fluids

(76) Inventor: Edwin Newman, Palmdale, CA (US)

Correspondence Address: Edwin Newman, 2854 Nandina Dr., Palmdale, CA, 93550, US

(21) Appl. No.: 11/800,453

(22) Filed: May 4, 2007

(51) Int. Cl. F03B 13/00

(52) U.S. Cl. 290/54

(57) ABSTRACT

A device for converting the varying pressure of wind and ocean current on a sail into electrical energy. The coefficient of drag on the sail and therefor the power input of the device is increased by constructing a box with one surface being the sail and the opposite surface left open to the oncoming wind or ocean current. Power conversion may be done with either a gear train or preferably hydraulically using a Bourdon tube.

### BACKGROUND OF THE INVENTION

Many attempts have been made to “solve” our worldwide energy crisis. The only realistic permanent solution lies in the development inventions for extracting renewable energy. Regarding wind and ocean current energy Hope et al (U.S. Pat. No. 4,088,429) and Hassard et al (U.S. Pat. No. 6,568,181) show a scoop facing the oncoming air or water current and assume this current will be forced through a narrow hole rather than travel around their devices. Any scoop or nozzle used this way is inefficient. Nevertheless since the power in an air or water current is defined as the rate of flow multiplied by its kinetic energy it would be advantageous to somehow accelerate the velocity of the flow artificially The power output is increased by the cube of the velocity, ie. in a geometric progression, more than balancing a decrease in an arithmetic progression for the small end of a scoop. Regarding wind energy in particular, Mooring (U.S. Pat. No. 7,157,805) proposes to use a sail instead of a propeller turbine. This is an improvement over using a propeller. For a propeller The power output must be multiplied by the Betz number, which is 0.593, the theoretical maximum efficiency. This is because much of the wind energy is blown through the propeller without affecting the blade velocity. But with a sail the power output may be multiplied by the coefficient of drag instead, which is about 1.1 so the overall system efficiency is greater. The power takeoff in U.S. Pat. No. 7,157,805 is mechanical but there is no effort made to artificially accelerate the wind velocity. Regarding ocean wave energy my patent (U.S. Pat. No. 6,781,253) as all other patents in the art, makes no attempt to artificially increase the frequency of ocean waves, but only their amplitude. The present invention also is concerned with converting wind energy into electrical energy using the force on a building, and converting ocean wave energy into electrical energy using the inherent elasticity of a hull of a ship. My patent (U.S. Pat. No. 7,043,904) addresses these methods. Yet in neither base is there an effort to increase artificially the kinetic energy input of wind or ocean waves. The present invention is presented to lessen the above difficulties.

### SUMMARY OF THE INVENTION

The basic idea of the invention is to have two reservoirs of fluid arranged so natural forces are made to press on elastic walls of each reservoir alternately. There is a nozzle connecting the reservoirs filled with the same fluid. This pipe has a smaller cross-sectional area than that of each reservoir. So if each reservoir is half full of fluid and the pressed wall of the reservoir is movable then fluid will be made to move through the converging diverging nozzle into the other reservoir at a higher velocity than the velocity of the pressed wall.

As applied to wind energy, there is a pole erected from the ground. Mounted on the pole is a structure appearing as shutters in an open box. When the shutters are closed this box increases the coefficient of drag. On each side of each shutter is a bag half full of air. Each bag is a reservoir of air. Pipes are led from each bag to ground level and connected to pipes from bags on the other side of a shutter. A reaction turbine is mounted in the connecting pipe and connected to a generator. As wind presses on one set of bags air in these bags is forced through the nozzles of the reaction turbine and fill the other bags on the opposite side of the shutters. When air is forced completely from the first set of bags the shutters are revolved and the operation is repeated. The invention is also applied to furnish auxiliary power to a ship. See also my U.S. Pat. No. 7,043,904. In the improved version of this invention a lever is laid near the keel along its whole length. The lever is made to pass through a hole in a bulwarks amid ship. As the hull is made to bend by wave action the lever is made to swing slightly up and down about a fulcrum. On each end of the ship the end of the lever is made to move a piston in a water-filled piston cylinder. A converging diverging nozzle is made to connect the two opposite ends of the piston cylinder, sending water through the throat of the nozzle at high velocity. Within the throat is an axial turbine which is shafted to a generator. Thus wave action is made to produce electric power for a ship. Applied to a building the invention is much the same in structure as on a ship but the lever is secured to a building framework so as the wind sways the building the attached lever is made to force the axial turbine to operate an electric generator. See further the second preferred embodiment of U.S. Pat. No. 7,043,904.

To provide power at long distances such as from ocean bed to shore further adjustments of structure of the invention are needed. As applied to ocean wave energy there are two pipes of large diameter extended from the sea bed to a low waterline. These pipes are not in the same location and are joined near their bottoms by a converging diverging nozzle. The two large pipes are considered to be reservoirs. In a “T” form a second small pipe is led from the nozzle throat to the shore. At the end of this second pipe is a valve controlling flow into two Bourdon tubes. A third pipe full of water and open to the atmosphere terminates in another valve controlling flow into the same Bourdon tubes. The two Bourdon tubes are made to operate a single generator alternately. The generator is kept at sea level by auxiliary machinery. As the standpipes are not in the same location offshore pressure in each pipe is different and causes low pressure to exist in the pipe to shore. The third pipe, full of water to the level of the wave crests is made to supply high pressure water to the Bourdon tubes alternately with the low pressure from offshore.

An alternative structure is shown where an axial turbine is placed in the throat of the nozzle offshore and shafted to a sealed generator. Wires transport electrical energy ashore. Since water is made to flow faster in the throat of the converging diverging nozzle the power output of the turbine is more than if it were placed in one of the larger diameter pipes.

To convert ocean wave energy into electric energy there is shown structure on the sea bottom which looks like the structure described for wind energy conversion only the working fluid is sea water. A pipe is led from the frontside bage on front of the shutters to the rearside bags. From the throat of the converging diverging nozzle as a “T” there is led a third pipe to shore. Ashore there is the same arrangement of pipes, Bourdon tubes and valves as before but the onshore structures are located in a hole as deep as the offshore structures.

As an alternative there is shown within the throat of the converging diverging nozzle offshore the same axial turbine shafted to a sealed generator outside the pipes and wire to shore as previously mentioned in regard to the wave energy structures.

The main object of the invention is to increase power output in certain renewable energy machinery.

The second object of the invention is to reduce the need for expensive gearing.

Further objects of the invention will become apparent from the study of the following portion of the specification, the claims and the attached drawings.

### BRIEF DESCRIPTION OF THE DRAWINGS

FIG. 1 is a perspective view of the invention configured to convert wind energy into electrical energy.

FIG 1a is a perspective view of a bag of the invention showing its connections to other parts of the invention.

FIG. 2 is a cross-sectional view of the energy conversion machinery of the invention as configured to convert fluid energy impacting a building or a ship into electrical energy.

FIG. 2a is a perspective view of the hull of a ship showing the location of the energy conversion machinery of the invention.

FIG. 2b is a perspective view of a building showing the location of the energy conversion machinery of the invention.

FIG. 3 is a view of the invention as configured to convert ocean wave energy into electrical energy.

FIG. 4 is a perspective view of the invention as configured to convert the energy of ocean currents into electrical energy.

FIG. 4a is a view of the invention integrated into U.S. Pat. No. 6,568,181 to better convert the energy of ocean currents into electrical energy.

FIG. 5 is a perspective view of alternative energy conversion machinery to convert the energy of ocean waves or currents into electrical energy.

### DETAILED DESCRIPTION OF THE PREFERRED EMBODIMENTS

### First Preferred Embodiment

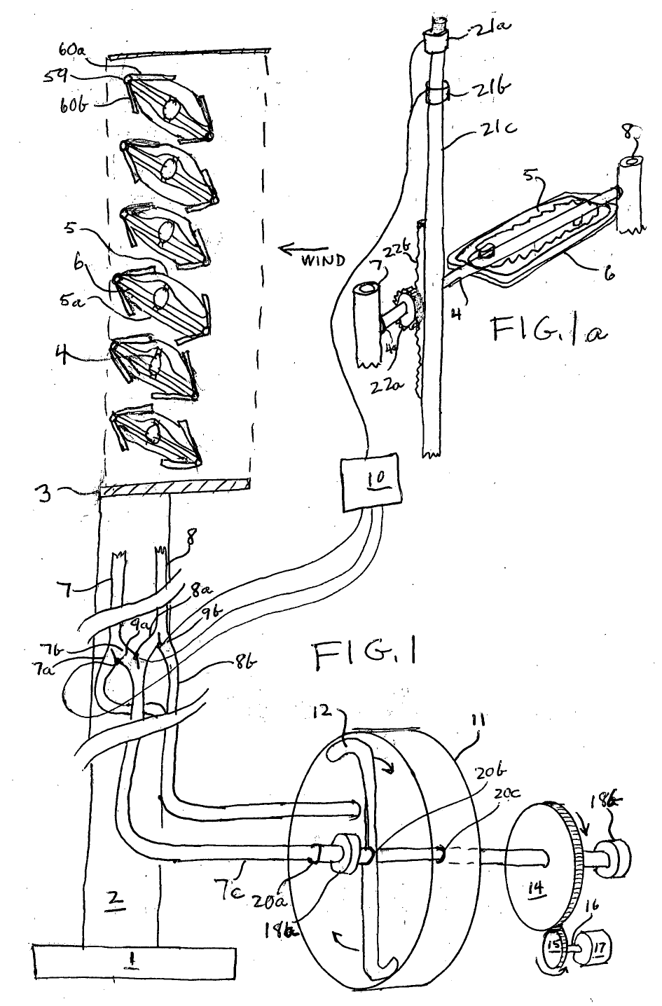

Turning to FIG. 1 we see a device to convert wind energy into electrical energy. On a base 1 fixedly attached to the earth there is erected a pole 2 upon which is fixedly attached a box 3 open at either end. My experience shows base 1 and pole 2 must be more strongly built that propeller type wind conversion machines. Mounted in box 3 are pipes 4 serving as pivots for shutters 6 which are operable by gears 22a,b and solenoid 21a,bto turn shutter 6 Through 189 degrees at a time. Upon bar 21c is mounted gear rack 22b which is made to mesh with pinion gears 22a which are mounted on pipes 4. Mounted on either side of shutters 6 are bags 5,5a. These bags are made of a foldable, non-stretchable material. Each bag is made to open into a separated portion of pipe 4. The pipe for bag 5 is led into pipe 7 through sliding seal 4a and the pipe for a bag 5a is led into common pipe 8. Common pipe 7 is made to divide into pipes 7a,7b. At the division is placed operatively a three-way valve 9a operated by a central processing unit 10. Pipe 7a is led into the inlet pipe 7c of reaction turbine 12 in housing 11. Common pipe 8 is made to divide into pipes 8a,8b. At the division is placed three-way valve 9b operated also by central processing unit 10. Pipe 8a is led into inlet pipe 7c and pipes 7a and 8b are led into a hole in housing 11. Pipe 7c is made to serve as the axis about which reaction turbine his made to revolve and is supported by thrust bearings 18a,18b. The portion of pipe 7c within housing 11 is connected to those portions of pipe 7c outside housing 11 by revolvable airtight couplings 20a,b,c. Pipe 7c is closed beyond reaction turbine 12. Transmission gear 14 is fixedly attached to pipe 7c between housing 11 and thrust bearings 18b. Operatively connected to gear 14 are pinion gears 15 shaft 16 and electric generator 17. Hinge 59 is made to run the entire length of each shutter 6 along the edge. Plates 60a,b form a roof for bags 5,5a and are fixedly attached to both hinge 59 and bags 5,5a so as hinge 59 is made to swing one plate is pressed upon a bag and the other plate pulls on the other bag.

In operation bags 5,5a are half full of air at ambient air pressure. Bags 5 are made to face the oncoming wind. Impacted by the wind bags 5 are emptied of air which is made to travel down pipes 7, 7b,7c with valves 9a,9c adjusted to permit this flow, and operate reaction turbine 12 by rushing out the turbine nozzles. The exhaust air is made to travel through pipes 8c,8b, and 8 through valve 9b to fill up bags 5a. Reaction turbine 12 is operatively connected to generator 17 through gears 14,15. When bags 5a are filled central processing unit 10 causes all 3-way valves to operate and solenoid 21 to flip over shutters 6 to present bags 5a to the wind and another power cycle is begun.

It will be noted that the cross-sectional area of the turbine nozzles is very much smaller than the cross-sectional area of the shutters 6. This increases the velocity of the air through the nozzles and the power of the turbine. Box 3 contains the air in such a way as to further increase the power input of the invention.

### Second Preferred Embodiment

The invention is applied to produce auxiliary power to operate a large ship.

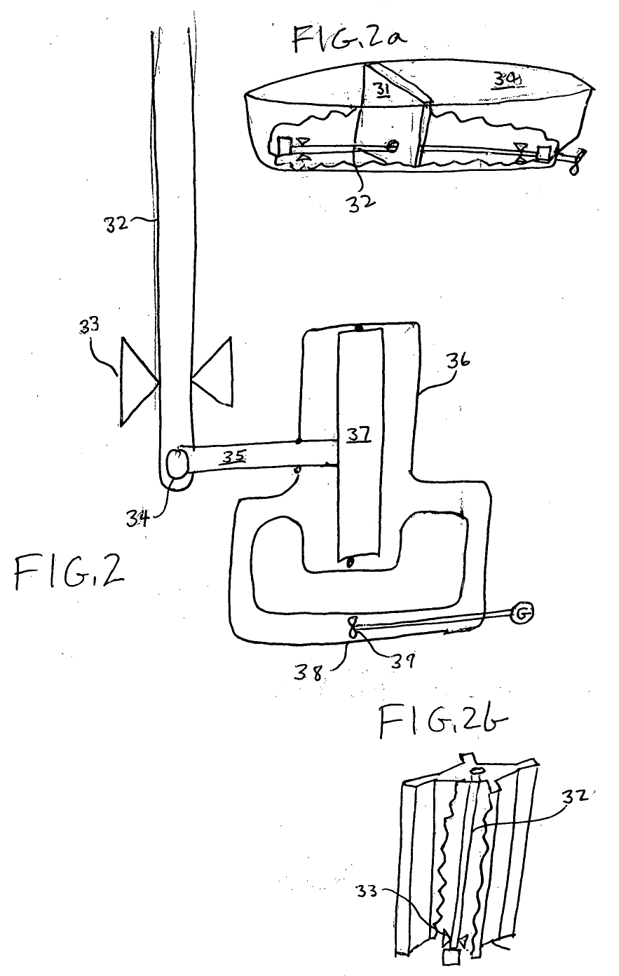

In FIG. 2a we see the hull of a ship 30 with a central bulwark 31. Lever 32 is laid along the keel. On either end of lever 32 is energy conversion machinery of the invention. Turning to FIG. 2 we see this energy conversion machinery comprises a fulcrum 33, a joint and an end of lever 32. Affixed to joint 34 is piston rod 35, piston 37 surrounded by piston cylinder and converging diverging nozzle 38, one end of which is made to open through a piston cylinder wall on a first side of piston 37 and the second end made to open through a piston cylinder wall on a second side of piston 37. Within converging diverging nozzle 38 is an axial turbine 39 operatively connected to an electric generator 17.

Piston cylinder 36 and converging diverging nozzle 38 are filled with water. The cross-sectional area of piston 37 is greater than the cross-sectional area of the throat of converging diverging nozzle 38 in which axial turbine 39 is located. In operation, as the ship hull 30 is made to hog due to wave action lever 32 is made to act as central bulwark 31 is made to press upon it. This forces piston 37 into reciprocal motion within piston cylinder 36. Water through the throat of converging diverging nozzle 38 is made to move faster than water within piston cylinder 36 due to the difference in cross-sectional areas. Thus axial turbine 39 is more able to produce usable power. It is recommended that lever 32 be made rectangular in cross-section. In the case of a ship's hull slots in various bulwarks will serve as guides for lever 32. In the case of a building frame (see infra) various floor joists will serve as guides for lever 32.

It should be stated that hull 30 is completely made of elastic materials. Naval Architects have succeeded in making hulls as rigid as they can, but this only means that a great deal of force is needed to hog the hull (ie. bend the hull) which always must occur to a small extent, which is all that is needed to operate the invention.

This invention may also be applied to a building framework so lever 32 is made to be vertical in the building framework as in my U.S. Pat. No. 7.043,904 (Second Preferred Embodiment col. 5 line 60).

### Third Preferred Embodiment

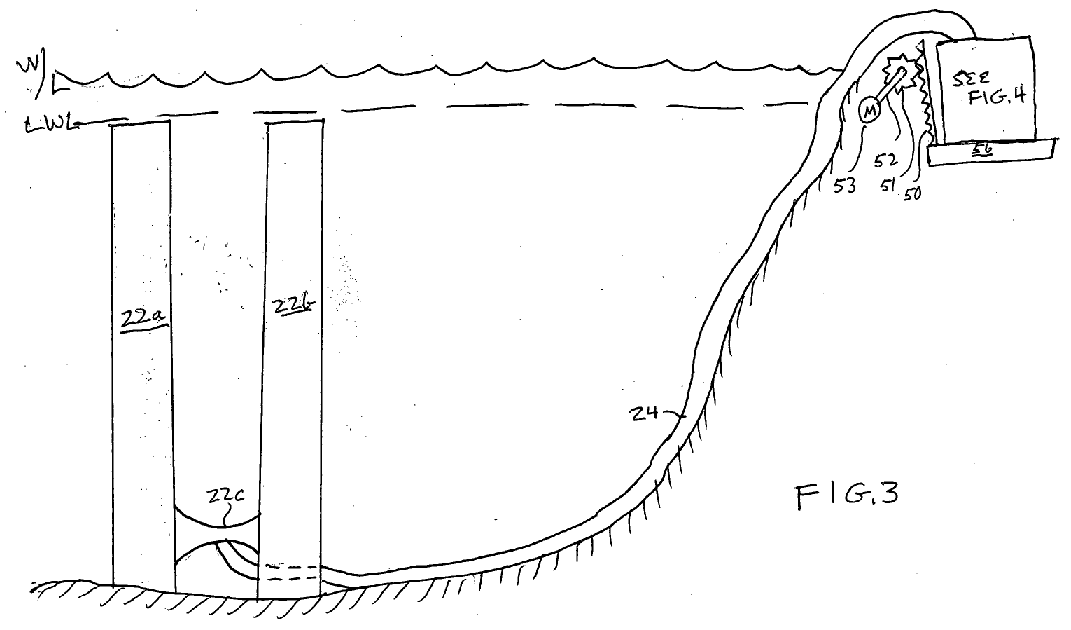

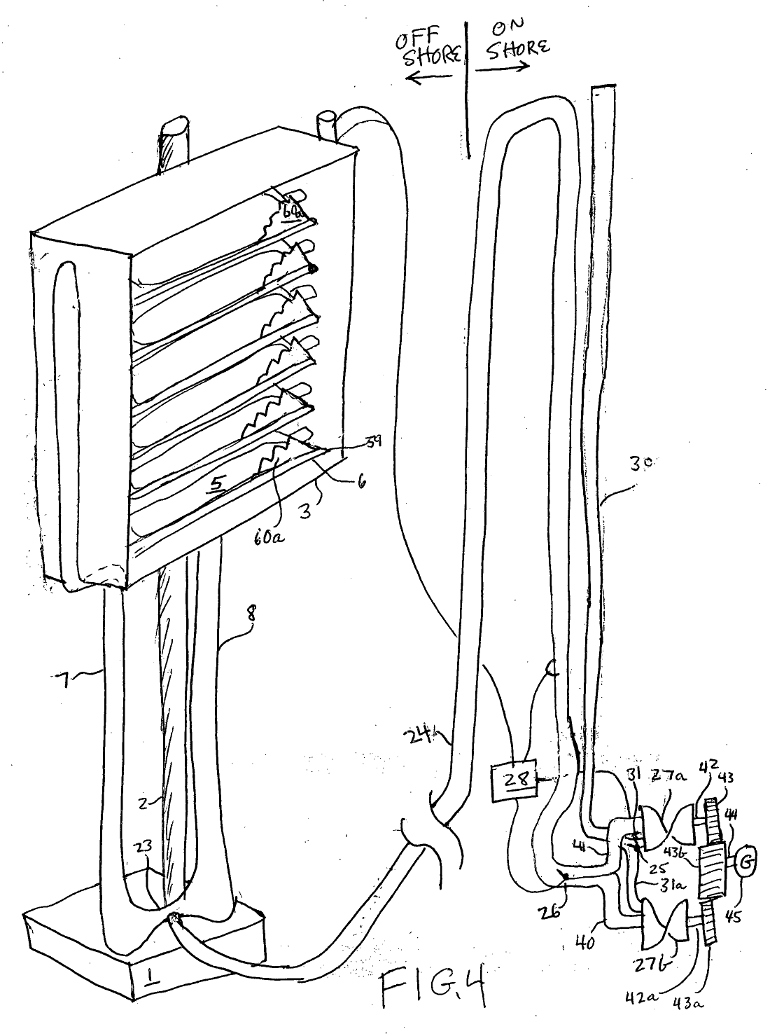

Turning to FIG. 3 we see two standpipes 22a,22b in the ocean extended from the ocean bottom to a low waterline and open at their tops. At the ocean bottom there is extended a converging diverging nozzle 22c joining pipes 22a,22b. Joined also to nozzle 22c is pipe 24 extended to shore. The end of pipe 24 is ashore but no part of it may be over 33 ft. above any waterline.

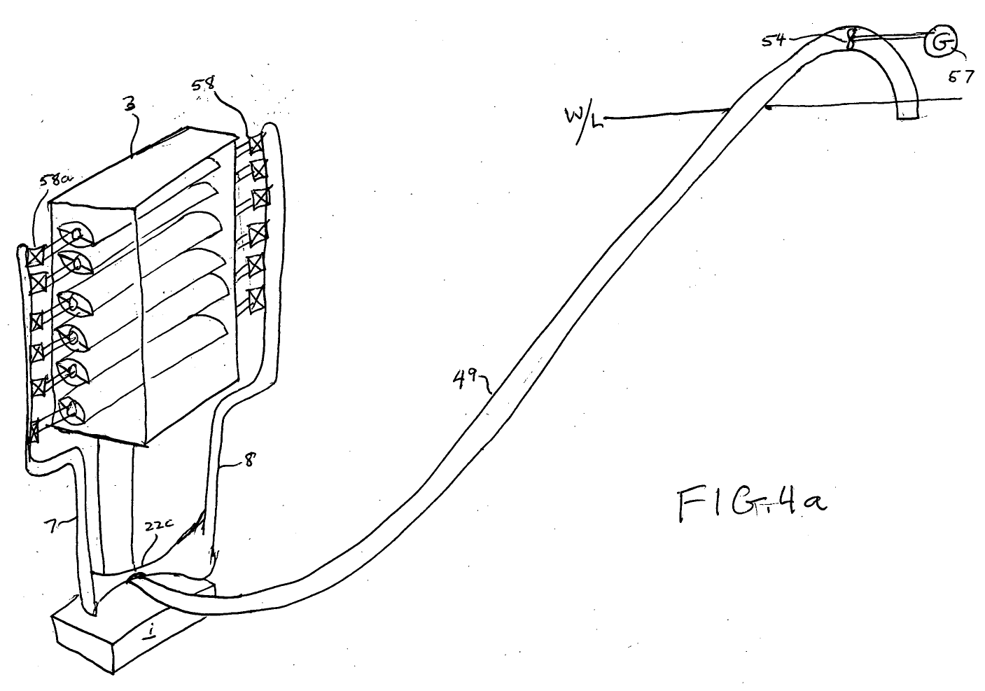

In FIG. 4 we see pipe 24 terminated by valve 26 controlling flow into Two Bourdon tubes 27a,b through pipes 40,41. Pipe 30 is a way of feeding water into the invention. Second valve 25 controls flow from pipe 30 into the same Bourdon tubes through pipes 31, 31a. Bourdon tube 27a is operatively connected to shaft 42 and gear 43. Bourdon tube 27b is operatively connected to shaft 42a and gear 43a. Gears 43a, 43 are made to mesh with common gear 43b which in its turn is operatively connected to shaft 44 and electrical generator 45. Clutches are affixed to shafts 42,42a. In operation, standpipes 22a and 22b are large in diameter and spaced apart. The throat of converging diverging nozzle 22c is small in diameter. Wave action will cause the pressure heads in the standpipes to vary in height. this will cause water in the throat of the converging diverging nozzle 22c to be moved at high velocity. Thus the pressure in pipe 24 will be decreased. The theoretical limit of this velocity is the velocity of sound in sea water, 5020 ft./sec. The low pressure in pipe 24 is transferred at the speed of sound to either Bourdon tube 27 or 27a. Higher pressure in Bourdon tubes will cause the tube to flex and extra water supplied through pipe 30 to enter Bourdon tubes 27a and 27b are made to do work on gears 43,43a alternately. As a Bourdon tube is made to relax water will be expelled from it and at the time it takes a pressure wave to be moved offshore excess water will be consequently expelled out the tops of standpipes 22a,22b. Central processing unit 28, through wires 60,61 regulate the operation of valves 25,26 so as one Bourdon tube is made to acquire energy the other Bourdon tube is made to spend its energy. Energy is acquired by the Bourdon tubes from the pressure head in pipe 30 which in this embodiment may only be as high as the wave crest. Energy is spent by a Bourdon tube in operating the electric generator and simultaneously evacuating water to the offshore structure. Motor 53, through the agency of shaft 52, sprocket 51 and gear rack 50 adjust the level of Bourdon tubes 27a, 27b rested on platform 56 to remain at sea level throughout the operation time for maximum efficiency of operation.

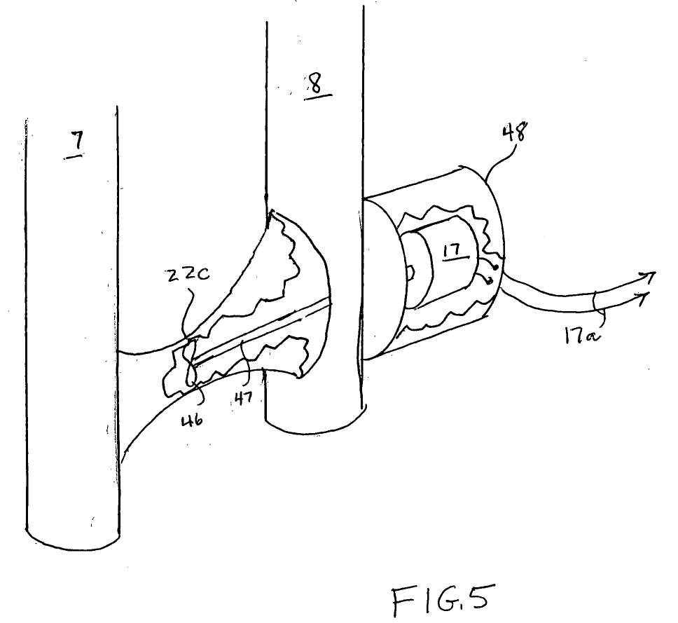

The user may wish, as is shown in FIG. 5 to install an axial turbine 46 which is shafted 47 to generator 17 in sealed housing 48. The axial turbine 46 is located in the throat of converging diverging nozzle 22c and transfer energy to shore by wires 17a. Access for maintenance is through standpipes 22a,22b.

### Fourth Preferred Embodiment

This embodiment shows how the invention can convert ocean current energy into electrical energy. FIG. 4 shows many of the same features as FIGS. 1 and 3. Similar functioning parts are numbered the same. FIG. 4 shows the shutter arrangement as FIG. 1 but the location is on an ocean bed. As in FIG. 3 there is shown a converging diverging nozzle 23 with pipe to shore 24. The machinery shore in FIG. 4 is located in a hole ashore as deep below the waterline as converging diverging nozzle 23.

Ocean current energy is converted as wave energy in this invention. As sea water is about 900 times as dense as air at sea level then potentially there is more energy available, depending on where the invention is located.

### Fifth Preferred Embodiment

Here the conversion of ocean current energy is converted into electrical energy in a different way from the Fourth Preferred Embodiment. In U.S. Pat. No. 6,568,181 a venturi tube is used to accelerate ocean current. This accelerated flow is supposed to suck fluid through a second tube extended from the throat of the venturi tube through a turbine on the surface and opening just below the waterline. The water in the second tube is evacuated out the rear of the venturi tube, operating the turbine and associated electric generator. As mentioned supra a venturi tube is inefficient for this purpose,

Turning to FIG. 4a we see the offshore structure as in FIG. 4 but instead of pipe 24 connected to Bourdon tubes there is placed within pipe 49 an axial turbine 54 and electric generator 57, both above the waterline. The turbine inlet is connected to the higher terminal portion of pipe 49 and is ended just below the waterline. there are check valves 58,58a operatively connected to each bag 5,5a and which is opened at a predetermined pressure so that water moved down pipe 49 and into either bag 5 or 5a is expelled into the ocean. In operation water is moved rapidly enough down pipe 49 and through converging diverging nozzle 22c so that enough suction is created to operate turbine 54 and generator 57.

From the above description it is apparent that the preferred embodiments achieve the objects of the present invention. Alternative embodiments and various modifications of the depicted embodiments will be apparent to those skilled in the relevant arts. These and other alternatives are considered to be equivalent and within the spirit and scope of the present invention.

I claim:

1. A group of devices to convert energy in naturally occurring fluids into electrical energy, comprising:
a. a first reservoir means of fluid impressible by pressure energy in naturally occurring fluids,
b. a second reservoir means impressible by pressure energy in naturally occurring fluids at a different time as said fluid in said first reservoir means,
c. nozzle means connecting said first and second reservoir means and,
d. energy conversion means comprising an electric generator operatively connected to said nozzle means,
so that said energy in said naturally occurring fluids is converted into electrical energy.

2. The group of devices of claim 1 wherein said reservoir means comprises:
a. a box open on two opposite ends,
b. shutters mounted on two other opposite ends of said box, and
c. bag means mounted on both sides of each said shutter, said bag means on a first side of a said shutter being a first said reservoir means and further bag means mounted on a second side of said shutter being a second reservoir means,
so as naturally occurring fluids impress said reservoir means then said bag means are made to empty their contained fluid into each other alternately through said nozzle means.

3. The group of devices of claim 1 wherein said reservoir means is defined by a wall of a piston and walls of an enclosing piston cylinder means.

4. The group of devices of claim 1 wherein said reservoir means comprises standpipes stood on an ocean bed and extended to a low waterline and being open at their tops.

5. The device of claim 2 wherein said energy conversion means comprises
(1) a turbine whose outlets are a converging nozzle, said turbine operatively connected to an electric generator, and
(2) valve means comprising openings to each said bag means and said converging nozzle and operatively connected to a central processing unit and a solenoid means so as said bag means are depleted by a force of wind said shutters are revolved to present said bag means to said force causing said turbine to revolve and electrical energy to be produced.

6. The device of claim 2 wherein said fluid is water and said pressure energy is from ocean current, said energy conversion means comprising a pipe extended from the throat of a converging diverging nozzle to a location ashore at the same depth as said nozzle and ending in a three way valve, said valve containing a second opening to a water filled inlet pipe extended to ground level and a third opening to a second three way valve whose second and third openings are to pipes operatively connected to bourdon tubes operatively connected to gears and an electric generator, said valves and said shutters operated through a central processing unit so said throat of said converging diverging nozzle means is made to operate as an energy sink and as said ocean current presses said bag means electricity is produced.

7. The device of claim 3 wherein said pressure energy is made to press said piston wall through the agency of a lever whose location is selected from the group of:
(a) within a ship hull and wherein said lever has a first end operatively connected to a central bulwark of said hull and whose second end is at an end of said ship with a pivot operatively connected to said lever and said lever operatively connected to said piston wall, said lever being of rectangular cross section and restrained from unnecessary movement by slots in bulwarks of said hull, and
(b) within a building and wherein said lever has a first end operatively connected to said building framework and whose second end is substantially at ground level with a pivot operatively connected to said lever, said lever being of rectangular cross section and restrained from unnecessary movement by slots in said building framework so as pressure energy presses on said lever from the wind electrical energy is produced.

8. The group of devices of claim 2 wherein said natural fluid is water and said energy conversion means is a turbine within the throat of a converging diverging nozzle, an electric generator operatively connected to said turbine, and wire means from said generator to a shoreline, so as water is made to flow through said converging diverging nozzle, said turbine is made to operate and electrical energy is produced.

9. The device of claim 4 wherein said energy conversion means is as described in claim 8 so as ocean wave action occurs electrical energy is produced.

10. The device of claim 4 wherein said energy conversion means is as described in claim 6 so as ocean wave action occurs electrical energy is produced.

11. The device of claim 2 wherein said energy conversion means comprises a pipe whose first end is operatively connected to the throat of a converging diverging nozzle and whose second end is made to touch substantially the surface of said ocean after being led to rise above the surface of said ocean so as to form a suction pipe, and a turbine within said suction pipe and an electric generator operatively connected to said generator above said surface so as water is made to move through said turbine by suction, electricity is produced.

12. The reservoir means of claim 2 wherein said shutter further comprises:
(a) a hinge made to run the length of the outer edge of said shutter, and
(b) two plates on either side of said hinge and fixedly attached to said hinge and said bag wall, said plates substantially covering the area of said bag surface, so as fluid presses on a first bag then a second bag on the opposite side of said shutter will have its inner volume increased and pull air from said first bag into said second bag.
